(19) United States
(12) Patent Application Publication
(10) Pub. No.: US 2013/0228636 A1
(43) Pub. Date: Sep. 5, 2013

(54) PRESSURE COMPENSATING NOZZLE IMPROVEMENTS

(71) Applicants: Aloysius Johannes Sanders, Beverly (AU); Darren Troy Loechel, Beverly (AU); William Gordon Milne, Beverly (AU); Christopher Alan Appleton, Beverly (AU)

(72) Inventors: Aloysius Johannes Sanders, Beverly (AU); Darren Troy Loechel, Beverly (AU); William Gordon Milne, Beverly (AU); Christopher Alan Appleton, Beverly (AU)

(21) Appl. No.: 13/701,409

(22) PCT Filed: Jun. 3, 2011
(86) PCT No.: PCT/AU11/00701

§ 371 Date: Feb. 7, 2013

(30) Foreign Application Priority Data
Jun. 3, 2010 (AU) 2010902433

(51) Int. Cl. B05B 1/30

(52) U.S. Cl. CPC B05B 1/3006
USPC 239/533.1; 239/542

(57) ABSTRACT

This invention relates to a pressure compensator for use with an irrigation device, the pressure compensator comprising:
a body defining a fluid passageway for fluid flow;
an elastomeric membrane;
a substantially concave seating surface substantially covered by the membrane, said
seating surface having a peripheral edge against which said membrane locates, wherein the seating surface and the elastomeric membrane seated thereby are positioned in the fluid flow so as to be either parallel with or inclined at an angle relative to the fluid flow. An irrigation device incorporating the pressure compensator is also disclosed.

This invention relates to a means of compensating for pressure variations in water supply to irrigation devices, such as sprinklers.

### PRIORITY

This patent application claims priority from:

Australian Provisional Patent Application 2010902433, titled “PRESSURE COMPENSATING NOZZLE IMPROVEMENTS”, and filed on 3 Jun. 2010.

The entire contents of this application are hereby incorporated by reference.

### BACKGROUND OF THE INVENTION

Pressure compensators in irrigation equipment ensure that each sprinkler discharges at substantially the same volume flow rate. Supply pressure along a distribution line can vary considerably due to friction losses, resulting in a significantly lower pressure at the end of a long run. In addition, irrigation lines installed on a slope with a significant height variation from one end to the other will also suffer considerable pressure variations along the line. This would result in some areas of a crop receiving more water than others unless some form of pressure compensation is used.

The applicant previously devised a pressure compensator for an irrigation sprinkler that addressed at least some of the above stated problems. This pressure compensator is as disclosed in U.S. Pat. No. 6,145,760, the entire contents of which should be considered incorporated herein by way of reference.

The use of elastomeric discs in such pressure compensators is disclosed in U.S. Pat. No. 6,145,760. These elastomeric discs are positioned over apertures and the flow rate of water past the disc is regulated by the flexing of the disc over a flow path. Generally, the disc is positioned over a recess and has a water passageway which is progressively reduced in area as the disc flexes further into the recess.

A problem with existing pressure compensators is blockage and the difficulty in removing blockages. When the water supply is turned off, the elastomeric disc flattens so that the initial water flow, when next turned on, will flush away any blockages. However, the channels are often very small and therefore do not flush adequately.

Also, the use of such small channels requires a great degree of accuracy in manufacture to ensure consistent flow control.

It is an object of the present invention therefore to provide a pressure compensator of improved performance in one or more of the above described respects, or which at the least provides a useful alternative to known pressure compensators for irrigation sprinklers.

Other objects and advantages of the present invention will become apparent from the following description, taken in connection with the accompanying drawings, wherein, by way of illustration and example, an embodiment of the present invention is disclosed.

### SUMMARY OF THE INVENTION

In one aspect of this invention there is proposed a pressure compensator for use with an irrigation device, the pressure compensator comprising:
a body defining a fluid passageway for fluid flow;
an elastomeric membrane;
a substantially concave seating surface substantially covered by the membrane, said seating surface having a peripheral edge against which said membrane locates,
wherein the seating surface and the elastomeric membrane seated thereby are positioned in the path of fluid flow so as to be either parallel with or inclined at an angle relative to the fluid flow.

In one form, the body comprises a nozzle, and the seating surface and the elastomeric membrane seated thereby are upstream of, and either parallel with or inclined at an angle relative to a direction of elongation of the nozzle.

In one form, the fluid passageway and the direction of elongation of the nozzle are substantially aligned, and the seating surface and the elastomeric membrane seated thereby are inclined at an angle relative to the direction of elongation of the nozzle.

In one form, the membrane is a disc.

In one form, by virtue of being parallel to or inclined at an angle relative to the fluid flow direction, the seating surface has an upstream peripheral edge, and a downstream peripheral edge.

In one form, there is at least one recess portion on the upstream peripheral edge of said seating surface that defines an aperture between the disc and the seating surface when no force is applied to the disc, and which provides flow control as the contacting face of the disc flexes into the recess when force is applied to the disc.

In one form, the or each recess partly extends into the seating surface so that the flow past the or each recess is prevented by sufficient flexing of the disc into the seating surface.

In one form, one or more channels extend from the upstream peripheral edge to or near an aperture in the seating surface, each channel defining an aperture between the disc and the seating surface when no force is applied to the disc.

Rather than using one or more very fine or small width channels, it has been found that the use of a wider and deeper channel of greater length need not impair flow control. The advantages of a larger channel include: 1. a larger channel is less likely to block; 2. any blockage will clear more readily; and 3. a larger channel is easier to make due to being less sensitive to dimensional variation.

In one form, the body comprises a nozzle extending in the direction of fluid flow, so that the seating surface and the elastomeric disc seated thereby are either parallel with or inclined at an angle relative to a direction of elongation of the nozzle.

In one form, the aperture in the seating surface is an inlet to the nozzle.

In one form, the body comprises a fluid inlet within which the pressure compensator locates. In an alternative, the pressure compensator is located between a fluid inlet and fluid outlet for the body.

In one form, the body comprises one or more notches that partly extend into said seating surface, each notch defines an aperture between the disc and the seating surface when no force is applied to the disc.

These notches provide a further degree of flow control as the elastomeric disc flexes into the recesses. More particularly, these notches provide further flow control during initial stages of flexing of the disc. Further flexure will then cause the notches to be closed off which will then prevent flow past this portion of the elastomeric disc. Once this occurs, then other flow control arrangements such as the channels are relied upon.

In one form, the disc is circular and the seating surface is circular.

The elastomeric disc may be used in any number of different shapes. In one form, the disc is circular, but a square or elliptical shape may also be used and should be considered included within the meaning of the term “disc”.

In a further aspect, the invention may be said to reside in a pressure compensator for use with an irrigation device comprising:

a body defining a fluid passageway, fluid flow direction, and a nozzle extending in the direction of fluid flow;
an elastomeric membrane;
a substantially concave seating surface which is covered by said membrane, said seating surface having a peripheral edge against which said membrane locates,
wherein the seating surface and the elastomeric membrane seated thereby are positioned in the fluid flow and either parallel with or inclined at an angle relative to a direction of elongation of the nozzle.

In a further aspect, the invention may be said to reside in an irrigation device incorporating the above described pressure compensator.

In a further aspect, the invention may be said to reside in a means of compensating for pressure variations in water supply to irrigation sprinklers, the means comprising

a body defining a fluid passageway and fluid flow direction,
an elastomeric membrane,
a substantially concave seating surface which is covered by said membrane, said seating surface having a peripheral edge against which said membrane locates,
wherein the seating surface and the elastomeric membrane seated thereby are positioned in the fluid flow and either parallel with or inclined at an angle relative to the fluid flow direction.

### DESCRIPTION OF THE DRAWINGS

For a better understanding of this invention it will now be described with respect to an exemplary embodiment which shall be described herein with the assistance of drawings wherein:

FIGS. 1 and 2 are perspective views of a sprinkler incorporating a pressure compensator according to an exemplary embodiment;

FIG. 3 is a perspective view of the pressure compensator in isolation, where the elastomeric disc has been removed to permit visibility of body details;

FIG. 4 is a view of the pressure compensator body in FIG. 3, viewed from the end that seats the elastomeric disc;

FIG. 5 is front view of the pressure compensator inclusive of the elastomeric disc;

FIG. 6 is a cross-section view through the body taken along line A-A of FIG. 5; and

FIG. 7 is front view of the pressure compensator that is similar to FIG. 5, but including detail of hidden features.

In the following description, like reference characters designate like or corresponding parts throughout the several views of the drawings.

### DESCRIPTION OF THE PREFERRED EMBODIMENT

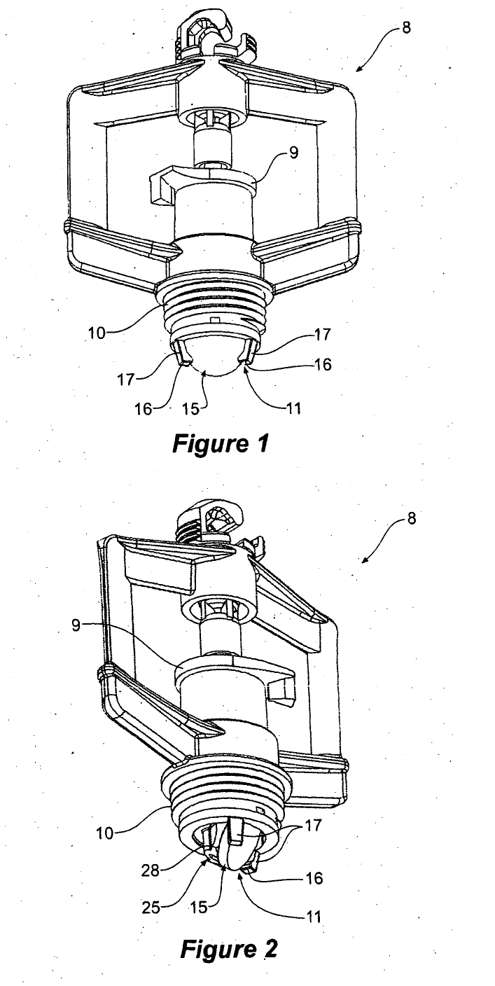

FIGS. 1 and 2 illustrate perspective views of an irrigation device comprising a pressure compensating means, the irrigation device being a sprinkler 8. The sprinkler 8 is typical of miniature sprinklers which distribute water via a rotor 9. The sprinkler has a fluid inlet 10 in an underside thereof within which a pressure compensator 11 locates, although the pressure compensator 11 is not limited to use in sprinklers of this type.

With reference to FIGS. 5 through 7, it can be seen that the pressure compensator 11 comprises two components. The first is a moulded body 12 defining a fluid passageway and fluid flow direction, and which includes a seating surface 13 that is inclined at an angle relative to the fluid flow direction through the fluid passageway. An elastomeric disc 15 is positioned over the seating surface 13, and is held in place by protrusions 16 on posts 17.

The seating surface 13 and the elastomeric membrane (a disc in this case) 15 seated thereby are inclined at an angle between 0 degrees, or parallel to the direction of fluid flow, and less than 90 degrees, or less than normal to the direction of fluid flow. In the illustrated embodiment this angle is approximately 30 degrees to the fluid flow direction, although this angle may be varied depending on the fluid flow conditions required.

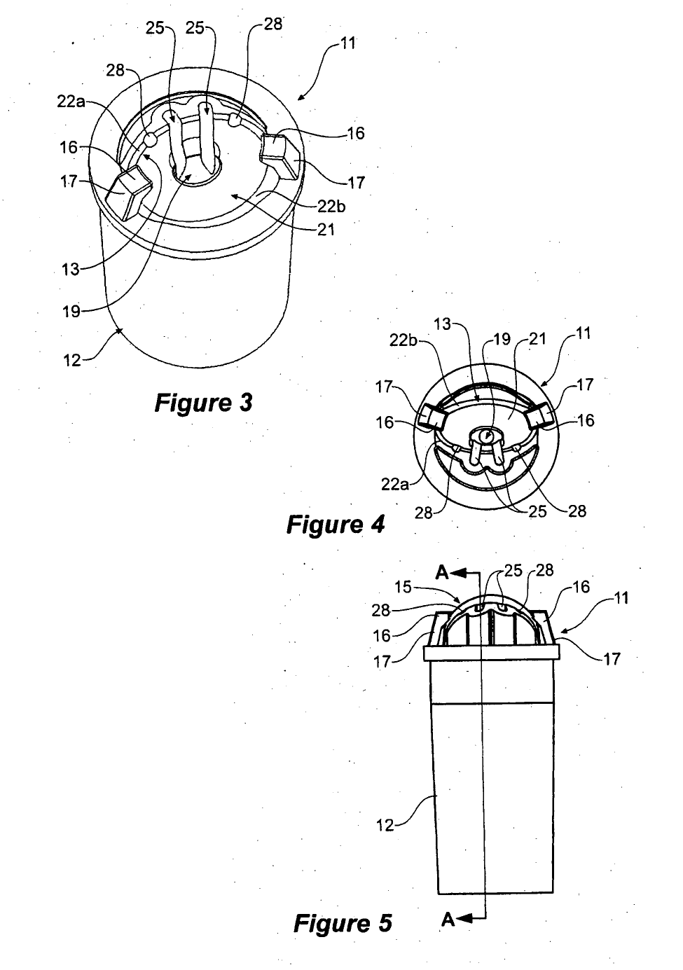

As can be seen in FIGS. 3 and 4, an aperture 19 is formed near the centre of the seating surface 13 and allows water flow through to a convergent nozzle 20 downstream of the seating surface 13 that produces a jet of water that impacts against rotor 9 so as to be redirected radially.

The elastomeric disc 15 locates over seating surface 13, the seating surface 13 comprising a concave recess formed by a conical wall 21 and a peripheral edge 22.

Because the seating surface 13 is inclined at an angle relative to the fluid flow direction, this has an upstream peripheral edge 22a, and a downstream peripheral edge 22b. Similarly, the elastomeric disc 15 has an upstream peripheral edge 15a, and a downstream peripheral edge 15b.

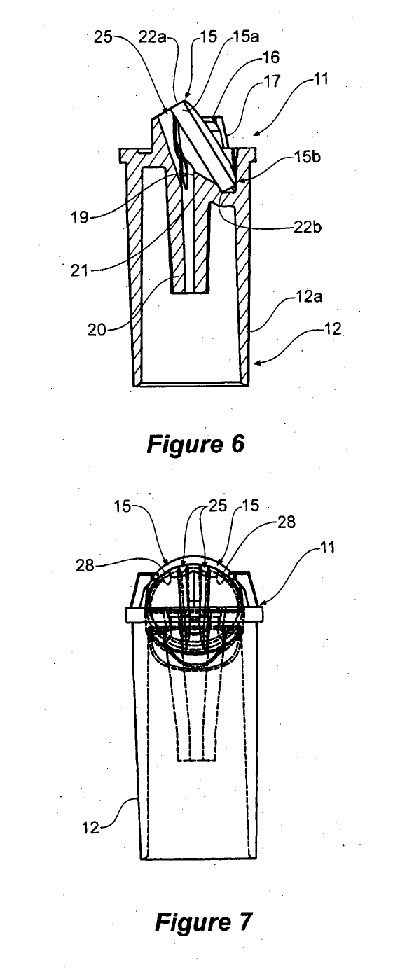

As can be seen in FIG. 6, the downstream peripheral edge 15b of the elastomeric disc 15 is located in a slot located between the downstream peripheral edge 22b of edge 22 and the outer wall 12a of the body 12, and the upstream peripheral edge 15a of the elastomeric disc 15 is retained by the protrusions 16 on posts 17. In this way, the elastomeric disc 15 is securely seated on seating surface 13.

Two channels 25 (although in some cases only one may suffice, or three or more may be required) extend from the upstream peripheral edge 22a to the aperture 19. It is primarily through these channels which the metered water supply flows to the nozzle 20, where aperture 19 is, is in the illustrated embodiment, the inlet to the nozzle 20, and the channels 25 also break through a wall of the nozzle 20.

As the supply pressure of the fluid increases, the disc 15 flexes into the conical recess of the seating surface 13. As the disc 15 seals against the conical wall 21, ingress for water is limited so as to be mainly via the channels 25. Accordingly, the degree of flexion of the disc 15 determines the extent of contact of the disc 15 along the channels 25 and therefore the effective area and length through which fluid can flow. Obviously, maximum deflection of the disc 15 will result in minimum aperture and channel size and flow along the channels 25, and therefore the greatest restriction to flow.

As can be seen in at least FIGS. 3 and 4, there is, in the illustrated embodiment, a notch 28 that extends a short distance into the seating surface 13 located on either side of the two channels 25. Notches 28 may be omitted or vary in number depending upon the desired flow characteristics. When the disc 15 is deformed so that it is in contact with the edge 22b flow will still occur via the notches 28. Further flexing of the disc 15 into the seating surface 13 will eventually cause the notches 28 to be closed so that the only means of flow control reverts to the channels 25. At this stage, the pressure will obviously be sufficient to force the concave deformation of the disc 15 so that flow control will only be by the channels 25.

The elastomeric disc 15 operates in the above described manner only once the fluid supply pressure reaches a certain pressure. Below this pressure, there is very little flexion of the disc 15, which in turn results in no pressure compensation below this given pressure.

As is discussed in U.S. Pat. No. 6,145,760, the upstream peripheral edge 22a and a portion of the conical wall 21 may, in conjunction with of channels 25 and/or notches 28, be provided with a recess (see item 26 of U.S. Pat. No. 6,145,760) which creates an aperture in the side of the seating surface 13 when no force is applied to the, disc 15. Instead of the disc 15 having to deform into the concave seating surface 13 to commence flow control, the edge of the disc 15 can deform into the recess 26. This deformation requires much less force, and therefore will provide a degree of flow control at lower pressures.

Any blockage pressure compensator 11 caused by build-up of debris will be flushed when fluid next flows through the sprinkler 8. If the pressure compensator 11 blocks through debris lodging in channels 25 or notches 28, the initial flow of water will have such energy as to stand a good chance of clearing the blocking material. The large area between the disc 15 and the edge 22b allows a forceful initial flow of water through the channel 25, and thereby aids in the clearance of any blockage. This flushing flow will continue until the disc 15 starts to deform.

The use of a large channel 25 also means that manufacturing tolerances do not need to be so fine.

Where fluid flow incident to the pressure compensator of U.S. Pat. No. 6,145,760 strikes the elastomeric disc of this at an angle normal to the disc resulting in break up of the stream and loss of stream energy, the fluid flow incident to the pressure compensator according to the present invention strikes an upstream edge 22a of the elastomeric disc 22.

As will be seen from the above description, the invention provides reduced disturbance to fluid flow through the pressure compensator 11, which results in less break up of the stream, meaning a more cohesive stream possessing greater energy and, as a result, increased sprinkler 8 throw (radius) and therefore wetted area for a given fluid supply rate. Moreover, because fluid flow is more directly directed to the aperture 19 and in turn the nozzle 20, nozzle 20 can be narrower at its inlet (aperture 19) and therefore of a design (such as a more slender design) that will release fluid with a greater outlet velocity, where this too will contribute to the improved throw and wetted area.

It is further anticipated that the design also provides improved flushing to clear blockages, as again, the stream has increased energy for clearing blockages.

The pressure compensating device 11 as described above will be capable of being used in a number of irrigation devices such as drip emitters or rotating nozzle-style sprinklers. The basic operating principle will remain the same regardless of the irrigation device used. Moreover, the number and configuration of any of the channels 25, recesses 26 and notches 28 may be varied along with characteristics of the elastomeric disc 15 so that there is a pressure compensator for almost every application.

It will be understood that the term “comprise” and any of its derivatives (e.g. comprises, comprising) as used in this specification is to be taken to be inclusive of features to which it refers, and is not meant to exclude the presence of any additional features unless otherwise stated or implied.

Any and all publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

Although the disclosure has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. A pressure compensator for use with an irrigation device, the pressure compensator comprising:
a body defining a fluid passageway for fluid flow;
an elastomeric membrane;
a substantially concave seating surface substantially covered by the membrane, said seating surface having a peripheral edge against which said membrane locates,
wherein the seating surface and the elastomeric membrane seated thereby are positioned in the path of fluid flow so as to be either parallel with or inclined at an angle relative to the fluid flow.

2. The pressure compensator of claim 1, wherein the body comprises a nozzle, and the seating surface and the elastomeric membrane seated thereby are upstream of, and either parallel with or inclined at an angle relative to a direction of elongation of the nozzle.

3. The pressure compensator of claim 1, wherein the fluid passageway and the direction of elongation of the nozzle are substantially aligned, and the seating surface and the elastomeric membrane seated thereby are inclined at an angle relative to the direction of elongation of the nozzle.

4. The pressure compensator of claim 1, wherein the seating surface has an upstream peripheral edge, and a channel extends from the upstream peripheral edge of the seating surface to or near a fluid outlet aperture in the seating surface, the or each channel defining a fluid inlet aperture between the respective peripheries of the elastomeric membrane and the seating surface.

5. The pressure compensator of claim 4, wherein the fluid outlet aperture in the seating surface is an inlet to the nozzle.

6. The pressure compensator of claim 4, wherein the depth of the or each channel in the seating surface is reduced as the or each channel approaches the fluid outlet aperture in the seating surface.

7. The pressure compensator of claim 4, wherein fluid flow through the or each channel and to the fluid outlet aperture in the seating surface is restricted and/or prevented by flexing of the disc toward the seating surface when a predetermined fluid flow rate is reached.

8. The pressure compensator of claim 1, wherein the body comprises an inlet end which defines a fluid inlet to the fluid passageway through the pressure compensator, and wherein the elastomeric membrane and seating surface therefor are located at the inlet end and in the fluid inlet.

9. The pressure compensator of claim 1, wherein the body comprises retention means for retaining the elastomeric membrane against the seating surface therefor.

10. The pressure compensator of claim 4, wherein the body further comprises one or more notches at the upstream peripheral edge of the seating surface, where each notch defines an aperture between the disc and the seating surface when fluid flow rate is so low that insufficient force is applied to the disc to close the aperture.

11. The pressure compensator of claim 1, wherein the elastomeric membrane is a disc and the seating surface is circular.

12. An irrigation device comprising a pressure compensator of claim 1.

13. The irrigation device of claim 12, wherein the irrigation device is a sprinkler

14. (canceled)

15. (canceled)
